(19) United States
(12) Patent Application Publication
(10) Pub. No.: US 2021/0204491 A1
(43) Pub. Date: Jul. 8, 2021

(54) Growing Mat for Plants

(71) Applicant: MICROPOD LIMITED, Auckland (NZ)

(72) Inventors: Wenhao Xu, Auckland (NZ); Oliver James McDermott, Auckland (NZ); Hin Wai Brian Lai, Auckland (NZ)

(21) Appl. No.: 17/059,142

(22) PCT Filed: May 30, 2019
(86) PCT No.: PCT/NZ2019/050059

§ 371 Date: Nov. 25, 2020

(30) Foreign Application Priority Data
May 30, 2018 (NZ) 742892

(51) Int. Cl. A01G 24/44

(52) U.S. Cl. CPC A01G 24/44

(57) ABSTRACT

Disclosed is a growing mat for use in a hydroponic system, the growing mat including a mat of pressed and dried natural fibres having a top face and a bottom face, a plurality of discrete depressions incorporated into the top face of the mat, the space between adjacent depressions being between 1 mm-30 mm, one or more seeds disposed within the depressions in the top face of the seed mat and at least one binding agent to aid in retention of seeds in position within the depressions.

### FIELD OF INVENTION

This invention relates to an improved growing mat for use in germinating plants from seed. More specifically, the growing mat is a natural fibre seed mat used in hydroponic growing systems.

### BACKGROUND TO THE INVENTION

Seed mats and mulch mats are known in the horticulture industry for either promoting growth of existing plants, or as a medium for facilitating new plant growth.

Typically, layers of mulch or other compostable material are formed and rolled into a mat like shape, with seeds optionally being held between the layers of material, or held within the compostable material. The compostable material is then used as a nutrient source for germination and/or growth of the seeds or plants. When applied directly to the soil, the seed mats gradually decompose into the surrounding soil, with the plant roots extending through the mat into the ground.

One such known seed mat is described in U.S. Pat. No. 7,698,854 ('854), entitled “Crop Production Apparatus”. This patent discloses flexible sheet of biodegradable matting with seed impregnated within it. The matting may be formed from an upper layer, which may be a may be a flexible sheet of biodegradable starch film, PVC, TDPE etc., with seed impregnated on a lower layer formed from biodegradable material.

Similarly, US20030154653 ('653), “Fibrous Product Containing Plant Seed” discloses a seed mat for plant seeds and in one example demonstrates a seed mat having a fibrous sheet coated on a top side with a combination of seeds and a heatless binder such as a starch based adhesive or other polymeric binders.

While the above disclosures generally teach the concept of seed mats or growing mats, the growing mats themselves are not optimised for use in a hydroponic environment. In order to be successfully used in growing plants from seed in a hydroponic environment, the growing mats must be formed in such a way as to promote the germination of seeds in a desired orientation, to withstand the required water absorption without disintegrating and to enable simple harvesting of the germinated seeds on both a small and large scale. Optimised spacing and placement of seeds is also crucial in maximising yield and reducing seed wastage during both manufacture and use.

Some of the disadvantages of known seed mats when used in a hydroponic environment include the mats being too thick or bulky, particularly when saturated with water, such that their weight starts to damage the mat structure, or the mats themselves degrade too quickly. This is useful when used in a standard soil based environment, but in a hydroponic system it is preferably to have the growing mats maintain their integrity throughout the growing process, enabling the mat to remain sturdy until post-harvest, and to have growing mats that encourage correct growth orientation, which is crucial in a hydroponic system.

For growing systems that are designed for indoor use, particularly in areas where hygiene is important such as commercial and residential kitchens, growing mats that don't quickly decompose are beneficial for maintaining adequate levels of cleanliness and reducing any mess associated with harvesting the grown plants.

### OBJECT OF THE INVENTION

It is an object of the invention to provide an improved plant growing mat for use in a hydroponic system.

Alternatively, it is an object of the invention to at least provide the public with a useful choice.

### SUMMARY OF THE INVENTION

According to a first embodiment of the invention, there is provided a growing mat for use in a hydroponic system, the growing mat including;
a mat of pressed and dried natural fibres having a top face and a bottom face;
a plurality of discrete depressions incorporated into the top face of the mat, the space between adjacent depressions being 1 mm-30 mm;
one or more seeds disposed within the depressions in the top face of the seed mat; and
at least one binding agent to aid in retention of seeds in position within the depressions.

Preferably, the depressions extend at least partially from the bottom face of the mat, forming protrusions in the bottom face of the mat corresponding with the depressions in the top face of the mat.

More preferably, the seeds are held in a position at least partially extending from beneath the bottom face of the growing mat.

Alternatively, the depressions are dimensioned such that when a seed is disposed within a depression, the seed height is lower than the top face of the growing mat.

Preferably the top face of the mat is substantially planar.

Preferably, the mat has a overall thickness of between 1 mm-20 mm between the top face and lower surface of the depressions, most preferably, the mat has a overall thickness of 1.5 mm-7 mm.

Preferably, the plurality of depressions are formed as discrete depressions spaced uniformly or randomly apart from one another. The depressions may be formed as individual spots, rows, strips or formed in specific shapes in order to incorporate specific seed sizes.

Preferably, the plurality of discrete depressions are spaced in a grid pattern.

In one preferred embodiment, the depressions are formed as substantially round, conical, frustoconical, cylindrical, cuboid, cube, pyramidal or frustopyramidal depressions perpendicular to the top face of the growing mat. More preferably, the depressions each define an opening of the top face of the mat of between 1.5 mm-10 mm, more preferably, between 2 mm-5 mm in diametre for small seeds, or 5 mm-7 mm for large seeds.

In further preferred embodiments, the depressions are conical or frustoconical, with the side faces of the depressions angled at between substantially 20°-45° from vertical.

In alternative preferred embodiments, the depressions are cuboid.

In further preferred embodiments, the depressions extend between 0.5 mm-10 mm below the bottom face of the growing mat, most preferably between 1 mm-3 mm for small seeds, or 3-7 mm for large seeds.

Preferably, the growing mat includes one seed per depression.

Preferably, the space between the centre of adjacent depressions is between 4 mm-20 mm, more preferably, 4-10 mm.

In preferred embodiments the binding agent is an adhesive.

Preferably, the binding agent is a polymer based adhesive. The adhesive may be selected from polyvinyl alcohol (PVOH, PVA or PVAL), ethylene vinyl acetate (EVA) or a cationic starch.

Preferably, the binding agent is a binding layer located on at least the top face of the mat.

More preferably, the binding layer is a spray on adhesive applied to the top face of the growing mat to retain seeds in position, applied at discrete positions or as an adhesive sheet.

In optional embodiments, the binding layer is formed from a combination of adhesive and an amount of solid material.

In further preferred embodiments, the mat includes a grid of equally spaced depressions. More preferably, each depression is of substantially equal size. Even more preferably, the depressions are cuboid in shape.

Alternatively, the mat includes depressions in the form of rows or channels.

More preferably, each depression is of substantially equal size.

According to a further embodiment of the invention, the growing mat has an initial stiffness and a secondary stiffness, the secondary stiffness being at least 50% of the initial stiffness.

More preferably, the secondary stiffness of the mat is 75%-110% of the initial stiffness.

According to a further aspect of the invention, there is provided a growing mat for use in a hydroponic system, the growing mat formed from natural fibres, the mat comprising;
an undulating planar mat, the undulating planar mat having a top face and a bottom face, the undulating mat formed from a plurality of peaks, the outer surface of the peaks collectively forming the top face of the mat, and a plurality of troughs, the outer surface of the troughs collectively forming the bottom face of the mat;
one or more seeds disposed within the troughs of the undulating mat; and
at least one binding means, the binding means adapted to retain the seeds in position within the troughs.

Preferably, the binding agent is a polymer based adhesive. The adhesive may be selected from polyvinyl alcohol (PVOH, PVA or PVAL), ethylene vinyl acetate (EVA) or a cationic starch. In preferred embodiments, the undulations are adapted in size such that a seed may be retained within the troughs at least in part by friction between the seed and the trough walls.

Preferably, the growing mat includes seeds sized between 2 mm-20 mm.

According to a still further aspect of the invention, there is provided a growing mat for use in a hydroponic system, the mat formed from natural fibres and including a plurality of seeds disposed therein, wherein the mat has an initial stiffness and a secondary stiffness, the secondary stiffness being at least 50% of the initial stiffness.

More preferably, the secondary stiffness of the mat is 75%-110% of the initial stiffness.

Preferably, the growing mats of the present invention are formed from natural plant or animal fibres selected from paper pulp, air laid paper, wood pulp, coconut pulp, bamboo, tissue paper, cotton fibres, coir, coco peat, jute, hemp, hair, wool or other lignocellulosic plant material or cellulosic fibre.

Most preferably, the growing mats formed from a mixture of chemical thermo-mechanical paper pulp and coconut husk fibre (cocopeat).

In preferred embodiments the growing mat is formed using fibres having a width of between 2.5 μm-200 μm.

Preferably, the growing mat is formed using fibres having a length of between 200 μm-5000 μm.

Preferably, the seeds incorporated into the growing mats may be selected from herb seeds, vegetable seeds, fruit seeds or ornamental plant seeds. Most commonly used seeds include carrot, lettuce, sprouts, celery, arugula, basil, radish, chives, broccoli, mustard, mesculun, cress, watercress, parsley, fennel, chysanthemum, cilantro, sorrel, mint, dill, shisho, tender greens, spinach, beet, tatsoi, mitzuna, amaranth, chard, kale, mache, cabbage, pak choi, kohlrabi, wheatgrass, hemp, coriander, peas, komatsuna, sunflower or mixtures thereof.

In further embodiments of the invention the growing mat includes additional nutrients, fertilizers, additives, preservatives or fungicides.

Preferably, the shape of the growing mat is adapted to enable the mat to be received within a growing tray.

In further preferred embodiments, the mat includes a removable film covering the top face of the mat.

According to a further aspect of the invention there is provided a method for the manufacture of a growing mat for use in hydroponic systems, the method including;
a) hydrating an amount of one or more natural fibres;
b) applying a layer of hydrated fibres to a flat screen;
c) drying said fibres to produce a dry growing mat having a top face and a bottom face;
d) perforating or partially perforating the top face of the growing mat of c) to form a plurality of depressions;
e) placing one or more seeds in the plurality of depressions; and
f) applying an adhesive to the growing mat to retain the seeds in position.

In additional embodiments, the method may include one or more further steps selected from;
combining a range of natural fibres together in a slurry;
cleaning the natural fibres;
blending the natural fibres to reduce fibre size;
filtering the natural fibres by size;
colouring the fibres; and/or
adding nutrients, fertilizers, additives, preservatives or fungicides to the fibres.

For the purposes of this invention the term “initial stiffness” should be taken to mean the stiffness of the dry growing mat prior to the start of the hydroponic growing process. The term “secondary stiffness” should be taken to mean the stiffness of the dry growing mat as measured following absorption of water by the growing mat and a subsequent drying of the growing mat.

The term “mat” should be taken to mean a substantially planar, three-dimensional shape having a length and width significantly greater than the depth. While having an overall “planar” shape as a result of the dimensions, it is not intended that the mat must have a smooth surface, and may incorporate grooves, bumps, depressions or raised shapes in the mat surface, while retaining an overall planar shape.

The term “small seeds” referred to herein should be taken to mean seeds having a widest dimension of between approximately 0.5 mm-3 mm, with larger seeds having a widest dimension of greater than approximately 3 mm.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 shows a top perspective view of the growing mat in one embodiment of the invention;

FIG. 1A shows a top perspective view of the growing mat in an alternative embodiment of the invention;

FIG. 2 shows a side view of the growing mat of FIG. 1, with the depressions extending below the bottom face of the mat;

FIG. 3a shows a close-up side view of the growing mat without seeds in one embodiment of the invention with closely spaced depressions;

FIG. 3b shows a close-up side view of the growing mat without seeds in an alternative embodiment of the invention with more widely spaced depressions than those of FIG. 3a;

FIG. 4a shows a close-up side view of the growing mat with seeds in one embodiment of the invention with closely spaced depressions and seeds placed deeply within the depressions;

FIG. 4b shows a close-up side view of the growing mat with seeds in an alternative embodiment of the invention with seeds held shallowly within the depressions;

FIG. 4c shows a close-up side view of the mat of FIG. 3b, with seeds held shallowly within the depressions;

FIG. 5 shows a close-up side view of the growing mat of FIGS. 3b and 4c once the seeds have sprouted;

FIG. 6 shows an isometric view of the growing mat in an alternative embodiment of the invention with the depressions adapted for large seeds;

FIG. 7 shows a side view of the growing mat of FIG. 6; and

FIG. 8 shows a flow chart outlining the steps for producing the growing mat of FIG. 1 in one embodiment of the present invention.

### DETAILED DESCRIPTION OF PREFERRED EMBODIMENTS OF THE INVENTION

The present invention describes a growing mat for use in a hydroponic growing system. Hydroponic growing systems range from large scale commercial enterprises, to smaller scale growing systems that are suitable for use in the home environment or small area.

The basis of hydroponic growing is that plants are grown in the absence of soil, with a nutrient rich water solution providing the required elements to support plant growth. The success of such systems can be influenced by the type of growing media used, the support structures surrounding the plants in the system, as well as external factors such as temperature, light and humidity.

In use, the growing mat of the present invention is fortified with nutrients during manufacture and dried. The dried mat is then supported by a rigid structure and suspended over water, such that the mat is just saturated but not floating in the water. As the seeds germinate, the roots first absorb water from the growing mat, before penetrating the mat and absorbing the water below. The roots grow more quickly than the water depletes, and as a result of this the plant always has access to the water and exposed roots will have access to oxygen. At this point the mat will no longer be in contact with water and slowly start to dry.

As well as being suitable for use in the “wicking” type system above, the growing mats of the present invention may be used in other types of hydroponic systems, for example an ebb and flow (or flood and drain) type hydroponic system. In these systems, the grow tray supporting the growing mat is slowly flooded with nutrient solution, the solution is then drained after a certain period of time, or when a certain level of solution is reached. As the solution is drained from the try, oxygen is accessible to the root system. The flooding and draining of the system is repeated to provide an abundant amount of nutrients and oxygen for fast growth.

The growing mat of the present invention optimises plant yields, while also providing a solution for small scale hydroponic systems that is both cost effective and simple. In one embodiment, the growing mat of the present invention is formed as a small mat for use with bench top hydroponic systems. However, it should be understood that the growing mat may also be made for large scale operations and provided on rolls, as or large sheets, or in varying shapes and sizes.

The growing mat is particularly suited to use in the production of microgreens, which are vegetable greens harvested after sprouting as shoots, before the plants grow excessively large. Microgreens are suited to being grown at close proximity to each other, as they are typically harvested before the root systems or foliage become too large. Microgreens are also harvested without the root systems, allowing them to be cut directly from the growing mat when ready for consumption, allowing for easy disposal of the used mat and root systems.

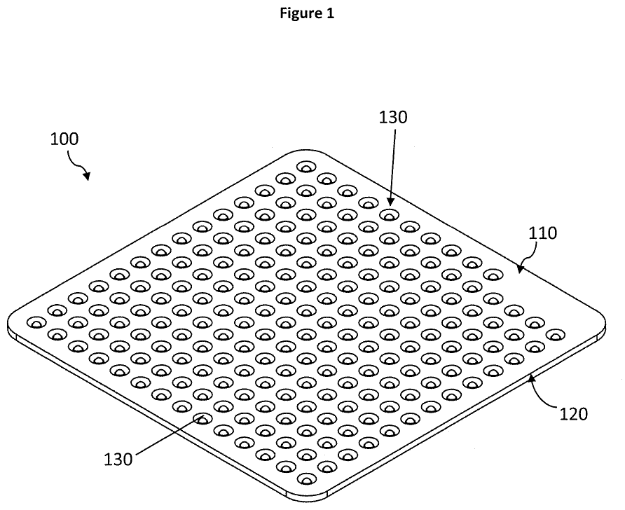

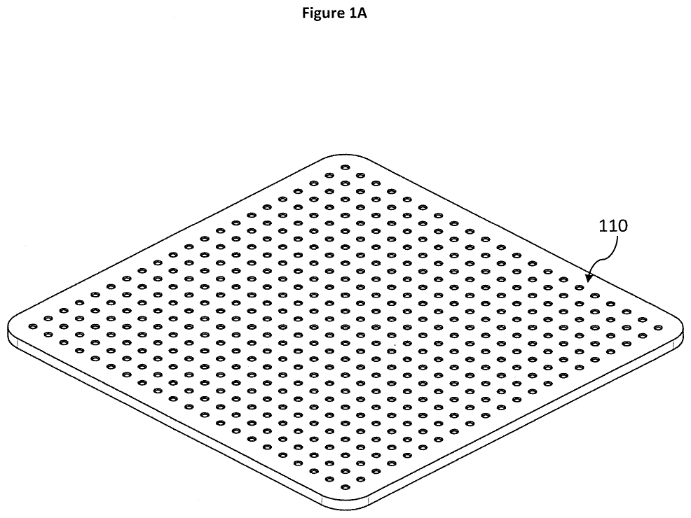

FIGS. 1-6 show the growing mat 100 with a number of non-limiting variations in the design.

The dimensions shown in the examples are a small selection of the different variations in size, shape and placement of the depressions in the mat 100 that are possible using the key concepts of this invention and should not be seen as limiting. Growing mat 100 is formed from natural fibres that are combined and pressed together in a substantially planar arrangement and then dried. In one method of manufacture, depressions are then added to the resulting dry sheet, providing a space for seeds to be located within. The seeds are in place using a soluble adhesive which dissolves slowly once contacted by water.

As seen in FIG. 1, mat 100 has a top face 110 and bottom face 120, forming two faces of an overall substantially planar sheet. Depressions 130 are formed within the mat, providing a semi-enclosed space where seeds 135 are then placed.

Mat 100 is designed in preferred embodiments to be light weight, with a thickness between top face 110 and bottom face 120 of between 1 mm-10 mm, with a preferred thickness of between 1.5 mm-2.5 mm when the growing mat is used with small seeds shown in FIG. 1. The thickness of the fibre mat 100 should be thin enough that it doesn't absorb too much water, which may result in the mat becoming water logged and losing structure, as well as taking an excessively long time to dry out; but thick enough that there are enough fibres to enable depressions to be formed on the surface of the mat without forming holes so large that seeds fall through, as well as being robust enough to withstand general handling and use.

FIG. 1A shows a similar mat to FIG. 1, with depressions 130 sized to retain smaller seeds within the growing mat 100.

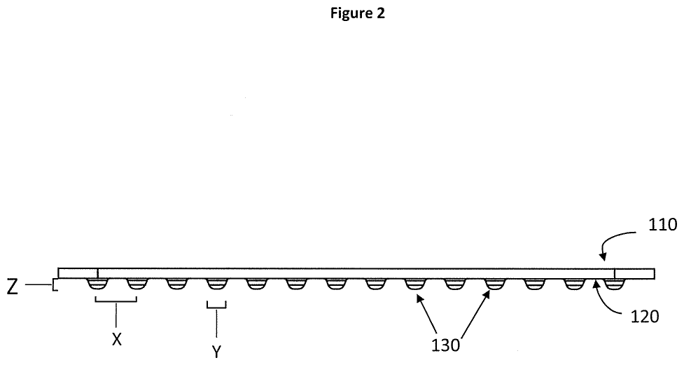

FIG. 2 shows a side view of mat 100, with depressions 130 shown extending downwardly from the bottom face 120. Depressions 130 may be positioned at a range of different spacings across mat 100. Depressions are typically formed with spacing of between 2 mm-20 mm and between the centre of each depression (X), with individual depressions having a width Y of between 1 mm-10 mm. For mats designed for the production of microgreens, depressions 130 are preferably spaced between 4-8 mm apart between adjacent centres, with width Y being between 1.5 mm-3 mm.

Depressions 130 extend below bottom face 120 of mat 100 as shown by depth Z. The depth of the depression will be determined by both the thickness of mat 100, as well as the size and shape of the seeds being incorporated within the depressions. It is envisaged that the depressions may range in depth Z from 0.5 mm-5 mm, however for the production of microgreens, depth Z is preferably 1-2 mm.

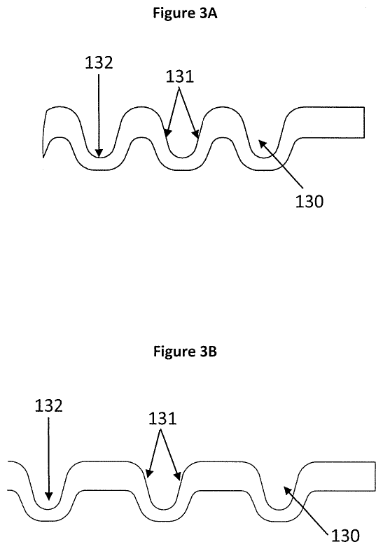

FIGS. 3a and 3b show close ups of depressions 130 (before the addition of seeds) in variations where depressions 130 are close together (FIG. 3A) and more widely spaced (FIG. 3B). Depressions 130 include inner side walls 131 and base 132, which are formed by the fibres of mat 100 being pushed down from the top surface 110 of mat 100, using a stamp, press or other such means to apply a downward force to mat 100.

In preferred embodiments the internal space defined by side walls 131 and base 132 is frustoconical in shape with the side faces of the depressions angled at between substantially 20°-45° from vertical. This shape provides sloping side walls help to hold seeds 135 of varying sizes with depression 130, although this shape is not intended to be limiting and depression 130 may be shaped as required to hold seeds of specific sizes or shapes. Other shapes that may be used include substantially round, conical, cylindrical, cuboid, cube, pyramidal or frustopyramidal depressions perpendicular to the top face of the growing mat.

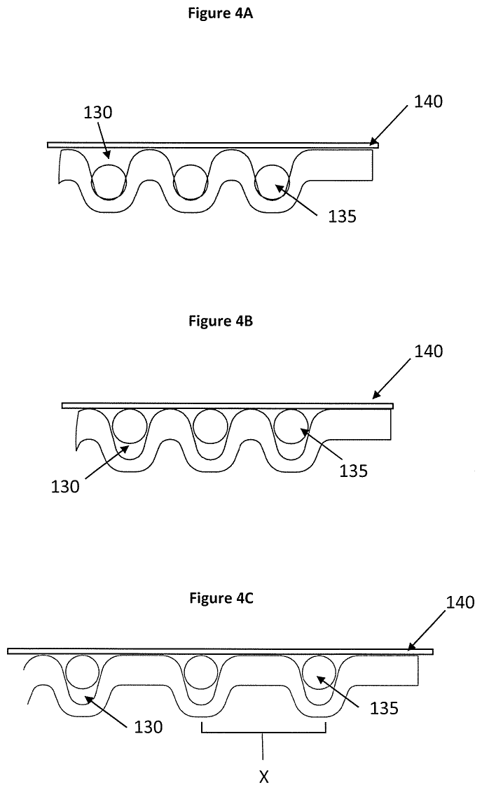

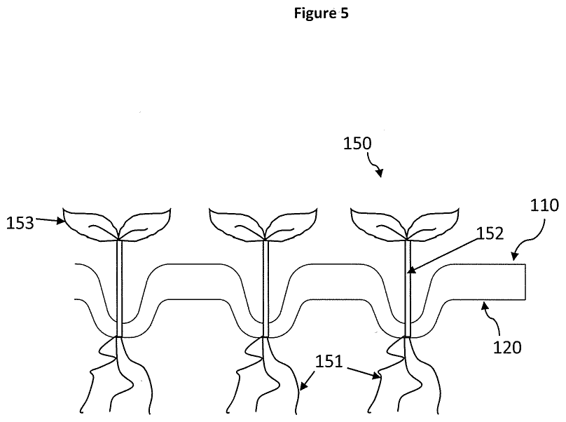

FIGS. 4A, 4B and 4C show the depressions 130 of FIG. 3A with seeds 135 disposed in the depressions at varying heights. In FIG. 4A, seeds 135 are seated deep in depression 130, with the seed resting on base wall 132. Larger seeds may be held higher in depressions 130 as seen in FIGS. 4B and 4C. Each depression 130 may also contain more than one seed 135, or seeds 135 may only be placed in alternate depressions for example. This variation allows for mats of a single format to be used for growing a number of different seedlings, which has economic advantages.

FIGS. 4A, 4B and 4C also show binder 140 located across the top of depressions 130 on the top face 110 of mat 100. Binder 140 is typically applied following the addition of seeds 135 to depressions 130, although in alternative embodiments it may be applied before the seeds, then the seeds themselves adhered to the binder when positioned in depressions 130.

In the current preferred embodiment, binder 140 is in the form of a water-soluble adhesive such as polyvinyl alcohol (PVOH), ethylene vinyl acetate (EVA) or a cationic starch, but any water-soluble polymer-based adhesive may be used. In FIGS. 4A, 4B and 4C binder 140 is applied as a single sheet of adhesive that is laid across the top surface 110 and dried, retaining the seeds in position and giving additional strength to the mat 100.

In other embodiments, binder 140 may be a spray on adhesive that is applied either before or after seed positioning, and may coat the surface of mat 100 as well as inside or partially inside depressions 130. In further embodiments the adhesive may also coat bottom 120 face of mat 100, in order to provide strength to the mat 100, or to provide further support for larger seeds held within depressions 130.

The adhesive may alternatively be applied to the growing mat in discrete areas using a spot application process, the discrete regions of adhesive specifically placed to retain seeds in positions within the depressions of the growing mat.

In further preferred embodiments a removable top sheet, made of cellulose for example, may be mounted across the top surface of the growing mat to protect the seeds. This is designed for removal before the growing mat is used.

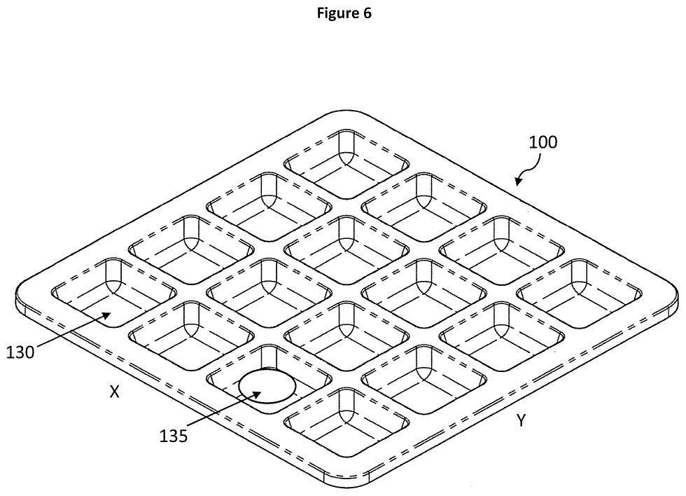

FIG. 5 shows the growing mat of FIG. 4C once seed 135 has germinated into seedling 150. Roots 151 penetrate the weakened fibres in base 132 of depression 130, extending downwardly into a nutrient solution located beneath mat 100.

Stem 152 is encouraged to grow in a vertical fashion by being retained within walls 131 of depression 130 and sprouts upwards producing leaves 153. Germination of seeds typically takes 2-8 days depending on variety, by which time binder 140 has dissolved, allowing stem 152 to shoot upwards.

In use, dry growing mat 100 has an initial stiffness A. Once the growing processes commences (triggered by the addition of a hydroponic water solution to the mat), mat 100 absorbs water from both the nutrient solution and the air, moistening the mat, dissolving adhesive layer 140 and reducing the overall stiffness of mat 100. This reduction in stiffness is typically managed by mounting mat 100 on a support structure (such as a plastic frame) which is part of a hydroponic system.

As water levels in the hydroponic system drop lower than mat 100, mat 100 begins to dry out. By harvesting time, mat 100 has preferably dried out partially, or may be completely dry, resulting in a mat having a secondary stiffness B. Dry mat 100 once again forms a solid mat, but with seedlings extending through both sides of the mat.

The design of the mat 100 described herein with a thin top layer, and fibres selected for their particular characteristics means that mat 100 doesn't absorb excess water which can lead to its disintegration during the growing process. The mat dries and regains at least a proportion of the initial stiffness A such that when lifted, or peeled from a support structure, it is able to retain the weight of plants 150, which can then be easily chopped from mat 150 for use.

Preferably, the thickness of mat 100 is such that the secondary stiffness B is at least 50% of the initial stiffness A, and preferably 75%-110% of the initial stiffness A. In some embodiments additives may be incorporated within the hydroponic system that help improve the rigidity of mat 100 as it dries out over time, which may result in mat 100 having a higher secondary stiffness B than the initial stiffness A.

Stiffness of mat 100 may be measured using a number of tests known in the art, including, but not limited to the Taber stiffness test, or other known ASTM standards for testing the stiffness properties of a material.

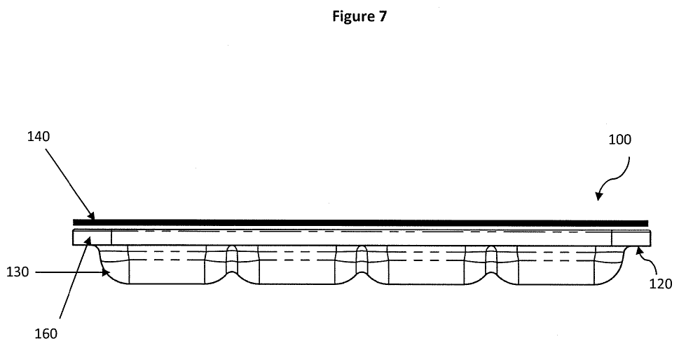

FIGS. 6 and 7 show growing mat 100 in an alternative arrangement particularly suitable for large seeds 135, such as wheatgrass, coriander, radish or pea.

In the embodiment shown in FIGS. 6 and 7, depressions 130 are arranged in a waffle pattern, which consists of an equally spaced grid of square depressions or indentations. Preferably each pocket is the same size, with an equal number of pockets in the X and Y dimension to promote seed growth and manage seed spacing to optimise yield.

In other embodiments not shown, the growing mat depressions may be formed in a row pattern consisting of long rectangular depressions, equally spaced across the X dimension and extending the full length of the Y dimension, with a consistent margin to the edge of the mat.

In all embodiments of the growing mat shown, the mats preferably retain a margin 160 of between 4 mm-7 mm around the mat edge to improve mat strength and ensure the seeds at the edges of the mat are fully supported, as well as providing a gripping surface to hold the mat following seed germination. Bottom face 120 of mat 100 is shown at margin 160, with depressions 130 extending below bottom face 120 of the mat.

In FIG. 7, removeable film 141 is shown mounted across top face of the growing mat 100, retaining seeds 135 within depressions 130. Film 141 may be used without, or in conjunction with an additional adhesive which helps to maintain the seeds in position within the depressions 130.

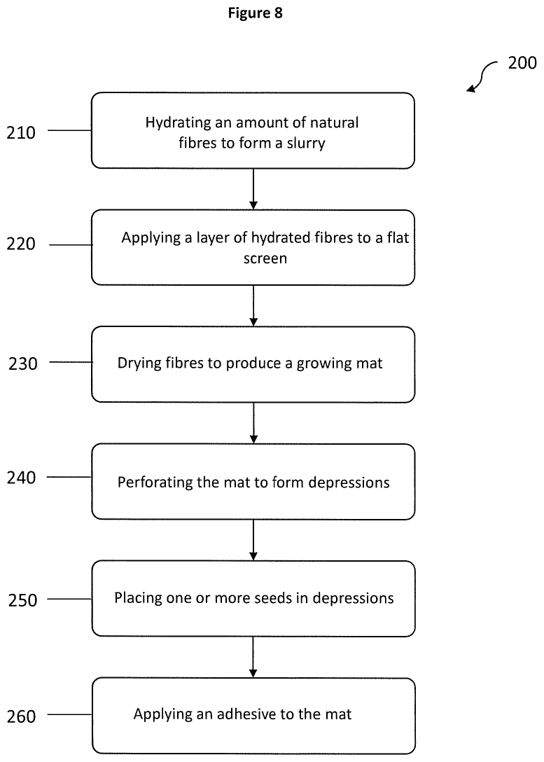

FIG. 8 outlines one method for manufacturing the growing mat 100 as described above which is particularly suitable for the manufacture of growing mats with small seeds.

As a first step, am amount of natural fibres or products formed therefrom are taken to form growing mat 100 and hydrated to form a slurry. At this point the fibres may be screened for size, blended to decrease fibre size, washed, bleached or filtered or coloured as required. Functional additives or chemicals such as fungicides, fertilisers, nutrients or preservatives may be added at this point as required.

Fibres are selected to be of such a length that they easily mat together to form a stable structure, but short enough that the fibres are able to be perforated by the roots of germinating seeds.

Fibres used may be selected from one or a combination of natural plant or animal fibres for example paper pulp, wood pulp, coconut fibre, coconut shell powder, air-laid paper, bamboo, tissue paper, cotton, jute, hemp, hair, wool or other lignocellulosic plant material. Combinations of different fibres may be selected based on specific characteristics such as fibre length, weight, strength and absorbency.

In one preferred example of a growing mat, the fibres are obtained from a mixture of 75% bleached chemical thermo-mechanical paper pulp (BCTMP) obtained from radiata pine and 25% coconut husk fibre (cocopeat). Cocopeat has a greater water absorbency than the paper pulp, and this ration has proven to provide a combination with the required strength that is absorbent enough to retain enough water for germination, but not so absorbent that the mat 100 deteriorates under the weight or the water, or is unable to dry out sufficiently to obtain a degree of stiffness prior to harvesting.

Individual characteristics for each of the fibre types may be obtained via suppliers, and from this information fibre mixtures with the desired properties for mats of a particular size, or for a particular seed type can be selected.

In one example where paper pulp is used, the growing mat is formed using fibres having a width of between 2.5 μm-200 μm and with fibres having a length of between 200 μm-5000 μm. These fibre sizes are not intended to be limiting, and the growing mats may be formed with longer and wider fibres. The fibre selection will depend on the size of the final product and its required strength, or the type of seeds being grown in the mat.

Once a slurry 210 having the desired properties has been formed, the slurry is spread across a perforated screen 220 at the desired thickness, then either left to dry 230 naturally or using fans, heating or other forced drying techniques.

The resulting dry mat is then depressed in specific regions 240 from the top face 110 to form depressions 130, either uniformly or randomly across the mat. The depressions may be formed using a mechanical punching machine, stamp or press that may be rolled across or stamped on to the dry growing mat. Alternatively, the depressions may be formed at the wet slurry stage by spreading the fibres over a ridged template or mould with depression incorporated.

Once depressions 130 are formed within the mat surface, seeds are placed 250 within some or all of the depressions. This process may be done by hand, or automated. A number of different types of seeds may be placed within a single growing mat, either randomly, or in patterns, or a single type of seed may be added to one growing mat.

Once seeds 135 are placed in depression 130, an adhesive sheet is placed across the top surface of the mat 100 with an amount of water to bind the sheet to the mat. Once dry, the adhesive sheet retains the seeds in place and adds a strengthening layer to the mat. Preferably, the adhesive is PVOH, but as mentioned above, a variety of other water-soluble adhesives may be used.

Once the adhesive is dry and set on the surface of mat 100, the growing mat is ready for use. Depending on the end commercial use, the mats may be cut to specific sizes or shapes to fit particular hydroponic systems or left as a large sheet or roll for larger scale operations.

In alternative embodiments where the growing mat incorporates larger depressions for larger seeds, the step of forming the depressions with a stamp or press may change to ensure the depressions have enough structural integrity to retain the seeds in the depressions.

Step 220 may be altered such that the slurry is left to dry across a molded screen, rather than a flat screen, so that depressions are formed during the drying process. The use of molded screens for drying allows for the shape, size and placement of the depressions to be altered according to the type of seed to be retained in the depressions. When this alternative embodiment is used, for example in the formation of the growing mat shown in FIGS. 6 and 7, the step of stamping or pressing the mat once dried is omitted.

The growing mat of the present invention provides a number of significant advantages over the growing mats currently known in the art.

The combination of fibres that are selected to allow the mat to absorb enough water to encourage germination, but still allow the mat to dry out and retain rigidity provides a simple, mess free system that is able to be used in a range of environments, including commercial kitchens where hygiene is very important.

The depressions 130 formed below the bottom face 120 of mat 100 encourage vertical growth of the seeds by retaining the seeds within depressions 130. Walls 131 direct the new stems upward, rather than sideways, and roots downward. Depressions 130 also create an area of weakened fibre, making it easier for the roots to penetrate the fibre and reach the nutrients below the mat.

Larger seeds are easily accommodated in the depressions 130 without having to increase the overall thickness of the mat, as would be required if the seeds were incorporated within the mat itself; being able to retain a thinner mat with larger seeds results in the mat not absorbing so much water that it is unable to dry out prior to harvesting, as well as providing commercial advantages in terms of production costs.

Seeds held flush/below the bottom surface 120 are closer to the water source, encouraging the downward growth of roots and any water absorbed from the environment through top surface 110 is directed downwardly through the depressions to the root systems and/or plant seeds.

The depressions 130 also make addition of seeds to the mat during manufacturing easier, as the seeds are retained in their individual holes. In addition, having seeds held lower or flush with the top surface of the mat allows for a single sheet of adhesive to be easily laid over the top surface of the mat without seeds being moved or resulting in air bubbles or regions where the adhesive hasn't adhered correctly.

The combination of the depressions and the upper adhesive layer means seeds are fully encased, which prevents damage during transport. Once hydrated, the entirety of the seed is saturated, increasing the germination success of the seeds.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A growing mat for use in a hydroponic system, the growing mat including;
a mat of pressed and dried natural fibres having a top face and a bottom face;
a plurality of discrete depressions incorporated into the top face of the mat, the space between adjacent depressions being between 1 mm-30 mm;
one or more seeds disposed within the depressions in the top face of the seed mat; and
at least one binding agent to aid in retention of seeds in position within the depressions.

2. The growing mat of claim 1, wherein the depressions extend at least partially from the bottom face of the mat, forming protrusions in the bottom face of the mat corresponding with the depressions in the top face of the mat.

3. The growing mat of claim 2, wherein the seeds are held in a position at least partially extending from beneath the bottom face of the growing mat.

4. The growing mat of claim 2, wherein the depressions are dimensioned such that when a seed is disposed within a depression, the seed is held substantially lower than the top face of the growing mat.

5. The growing mat of claim 1, where the mat has an overall thickness of between 1 mm-20 mm between the top face of the growing mat and the lowest outer surface of the depressions.

6. The growing mat of claim 5, wherein the mat has an overall thickness of 2 mm-7 mm between the top face of the growing mat and the lowest outer surface of the depressions.

7. The growing mat of claim 1, wherein the plurality of discrete depressions are spaced in a grid pattern.

8. The growing mat of claim 1, wherein the depressions are formed as substantially round, conical, frustoconical, cylindrical, rectangular, cuboid, cube, pyramidal or frustopyramidal depressions perpendicular to the top face of the growing mat.

9. The growing mat of claim 8, wherein the depressions are conical or frustoconical, with the side faces of the depressions angled at between substantially 20°-45° from vertical.

10. (canceled)

11. The growing mat of claim 1, wherein the depressions each define an opening of the top face of the mat of between 1.5 mm-10 mm.

12. (canceled)

13. The growing mat of claim 1, wherein the space between the centre of adjacent depressions is between 4 mm-8 mm.

14. The growing mat of claim 1, wherein the binding agent is an adhesive.

15. The growing mat of claim 11, wherein the binding agent is a binding layer located on at least the top face of the mat.

16. The growing mat of claim 1, wherein the growing mat has an initial stiffness and a secondary stiffness, the secondary stiffness being at least 50% of the initial stiffness.

17. The growing mat of claim wherein the secondary stiffness of the mat is 75%-110% of the initial stiffness.

18. (canceled)

19. (canceled)

20. (canceled)

21. The growing mat of claim 1, wherein the natural fibres are selected from plant or animal fibres including from paper pulp, air laid paper, wood pulp, coconut pulp, bamboo, tissue paper, cotton fibres, coir, cocopeat, jute, hemp, hair, wool or other lignocellulosic plant material or cellulosic fibre.

22. The growing mat of claim 16, wherein the growing mats are formed from a mixture of chemical thermo-mechanical paper pulp and cocopeat.

23. The growing mat of claim 1, wherein the growing mat is formed using fibres having a width of between 2.5 μm-5000 μm.

24. The growing mat of claim 1, wherein the seeds incorporated into the growing mats are be selected from herb seeds, vegetable seeds, fruit seeds or ornamental plant seeds.

25. (canceled)

26. (canceled)

27. (canceled)

28. The growing mat of claim 1, wherein the mat includes a removable film covering the top face of the mat.

29. (canceled)

30. (canceled)
